(19) United States
(12) Patent Application Publication
(10) Pub. No.: US 2015/0185345 A1
(43) Pub. Date: Jul. 2, 2015

(54) SYSTEM AND METHOD FOR SEISMIC IMAGING OF A COMPLEX SUBSURFACE

(71) Applicants: Uwe Albertin, Houston, TX (US); Linbin Zhang, Danville, CA (US)

(72) Inventors: Uwe Albertin, Houston, TX (US); Linbin Zhang, Danville, CA (US)

(73) Assignee: CHEVRON U.S.A. INC., San Ramon, CA (US)

(21) Appl. No.: 14/144,937

(22) Filed: Dec. 31, 2013

(51) Int. Cl. G01V 1/32; G01V 1/28; G01V 1/34

(52) U.S. Cl. CPC G01V 1/32; G01V 1/345; G01V 1/282

(57) ABSTRACT

A system and method for seismic imaging of a complex subsurface volume of interest may include generating partial image gathers, aligning each of the partial image gathers based on frequency-dependent phase information to created aligned partial image gathers, and stacking the aligned partial image gathers to produce a seismic image of the subsurface.

### FIELD OF THE INVENTION

The present invention relates generally to methods and systems for processing seismic data and, in particular, for improving seismic imaging of complex subsurface volumes, such as in areas of poor illumination.

### BACKGROUND OF THE INVENTION

Exploration for and development of hydrocarbon reservoirs may be efficiently done with the help of seismic data, which must be properly processed in order to allow interpretation of subsurface features. Generally, seismic data is acquired by using active seismic sources to inject seismic energy into the subsurface which is then refracted and/or reflected by subsurface features and recorded at seismic receivers.

When the subsurface is complex, such as in areas of faulting or with large differences in seismic velocity, the seismic energy can be reflected and/or refracted in such a way as to prevent energy from reaching part of the subsurface. In some cases, the phase of the seismic energy may be disrupted so that attempts to improve imaging using stacking fail. This is known as poor illumination. Due to the poor illumination, conventional seismic imaging methods will produce a shadow zone with weak or non-existent seismic events in a portion of the subsurface.

There is a need for improved methods and systems for imaging the subsurface in areas of complex geology where the illumination is poor.

### SUMMARY OF THE INVENTION

Described herein are implementations of various approaches for a computer-implemented method for seismic imaging in areas of poor illumination.

A computer-implemented method for seismic imaging of a complex subsurface volume of interest is disclosed. The method includes receiving, at a computer processor, a seismic dataset representative of the complex subsurface volume of interest; generating, via the computer processor, partial image gathers from the seismic dataset; aligning, via the computer processor, each of the partial image gathers based on frequency-dependent phase information to created aligned partial image gathers; and stacking the aligned partial image gathers to produce a seismic image of the subsurface.

In another embodiment, a computer system including a data source or storage device, at least one computer processor and a user interface used to implement the method for seismic imaging of a complex subsurface volume of interest is disclosed.

In yet another embodiment, an article of manufacture including a computer readable medium having computer readable code on it, the computer readable code being configured to implement a method for seismic imaging of a complex subsurface volume of interest is disclosed.

The above summary section is provided to introduce a selection of concepts in a simplified form that are further described below in the detailed description section. The summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

These and other features of the present invention will become better understood with regard to the following description, claims and accompanying drawings where:

FIG. 1 is a flowchart illustrating a method in accordance with an embodiment of the present invention;

FIG. 2 shows a simple example of one embodiment of the present invention;

FIG. 3 shows a result of an embodiment of the present invention compared with a conventional result;

FIG. 4 shows another result of an embodiment of the present invention compared with a conventional result;

FIG. 5 shows another result of an embodiment of the present invention compared with a conventional result;

FIG. 6 shows another result of an embodiment of the present invention compared with a conventional result;

FIG. 7 shows another result of an embodiment of the present invention compared with a conventional result; and

FIG. 8 schematically illustrates a system for performing a method in accordance with an embodiment of the invention.

### DETAILED DESCRIPTION OF THE INVENTION

The present invention may be described and implemented in the general context of a system and computer methods to be executed by a computer. Such computer-executable instructions may include programs, routines, objects, components, data structures, and computer software technologies that can be used to perform particular tasks and process abstract data types. Software implementations of the present invention may be coded in different languages for application in a variety of computing platforms and environments. It will be appreciated that the scope and underlying principles of the present invention are not limited to any particular computer software technology.

Moreover, those skilled in the art will appreciate that the present invention may be practiced using any one or combination of hardware and software configurations, including but not limited to a system having single and/or multiple processor computers, hand-held devices, tablet devices, programmable consumer electronics, mini-computers, mainframe computers, and the like. The invention may also be practiced in distributed computing environments where tasks are performed by servers or other processing devices that are linked through one or more data communications network. In a distributed computing environment, program modules may be located in both local and remote computer storage media including memory storage devices.

Also, an article of manufacture for use with a computer processor, such as a CD, pre-recorded disk or other equivalent devices, may include a tangible computer program storage medium and program means recorded thereon for directing the computer processor to facilitate the implementation and practice of the present invention. Such devices and articles of manufacture also fall within the spirit and scope of the present invention.

Referring now to the drawings, embodiments of the present invention will be described. The invention can be implemented in numerous ways, including, for example, as a system (including a computer processing system), a method (including a computer implemented method), an apparatus, a computer readable medium, a computer program product, a graphical user interface, a web portal, or a data structure tangibly fixed in a computer readable memory. Several embodiments of the present invention are discussed below. The appended drawings illustrate only typical embodiments of the present invention and therefore are not to be considered limiting of its scope and breadth.

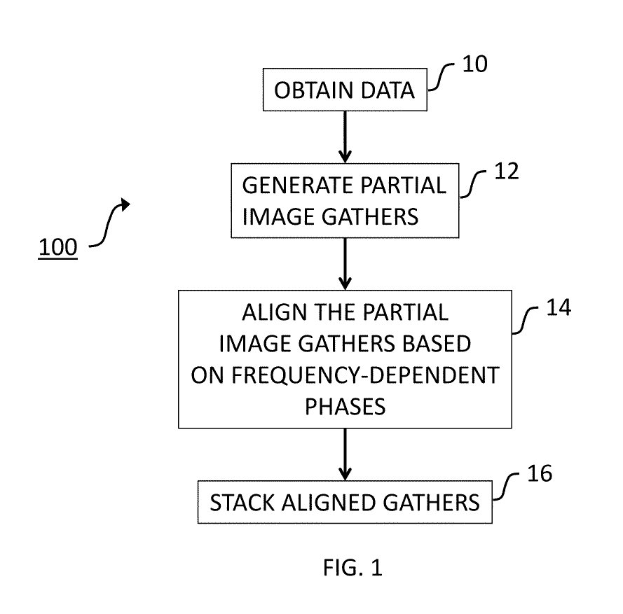

The present invention relates to seismic imaging in areas of poor illumination. One embodiment of the present invention is shown as method 100 in FIG. 1. At operation 10, a seismic dataset is obtained. This seismic dataset is representative of the subsurface volume of interest. It may be recorded data or synthetic data. It may be a marine dataset or a land dataset. Operation 10 may involve the actual seismic survey or may be the process of reading or receiving the seismic data from a source such as a data storage device (e.g. hard drive). The seismic data is a record of the seismic energy that has traveled through the subsurface volume of interest and includes both amplitude and phase information for a variety of source and receiver combinations.

At operation 12, partial image gathers are generated. This may be accomplished, for example, by Reverse Time Migration, Kirchhoff, Beam, or One-way Wave-equation migration, or in the computation of a gradient for Full Waveform Inversion, or Ray or Wave-equation based Tomography or Migration Velocity Analysis. For any of these imaging/inversion methods, a 3-D image may be produced with a first axis that is in time or depth, a second axis that is in geographical space (e.g. common depth point location, x location, etc.) and a third axis that represents the partial image data set of interest, i.e. common-shot, common receiver, common surface offset, subsurface offset, subsurface crosscorrelation time, subsurface reflection angle, or any other suitable set of partial images. Partial images are imaged, and the traces corresponding to partial image are displayed side by side according to a common image location determined by the second geophysical space axis stated above, to form a gather appropriate for the partially imaged data sets, such as angle gathers, surface offset gathers, subsurface-offset gathers, etc.

In areas where the subsurface is complex, it is likely that the events that appear in the partial image gathers will be weak and/or not aligned such that the maximum amplitude of a given event does not appear at exactly the same time or depth on all of the traces in the partial image gathers. This may occur as a result of seismic energy encountering a high-contrast boundary (e.g. sediment/salt). The energy may be reflected, refracted, and may have its phase altered is different ways as it encounters the boundary at different incidence angles. Conventional methods for seismic imaging often stack (sum) the 3-D images along the partial image axis. In poorly illuminated areas, stacking will result in image degradation or an improperly formed image.

Referring again to FIG. 1, at operation 14 the partial image gathers are aligned based on frequency-dependent phase information. This can be done in several ways, for example with an objective function optimization or by matching to a pilot trace.

The objective function optimization may, for example, be designed to maximize the stack power through phase alignment. This may be accomplished starting from the simple stack calculation:

$$s ( t ) = {\sum }_{i} {f}_{i} ( t )$$

where s(t) is the stack trace as a function of time and ƒᵢ(t) are the traces that are summed together. The stack power objective function J is:

$$J = {\sum }_{t} {( s ( t ) )}^{2}$$

note that here the summation is over time t.

Although seismic data is recorded in time, it is a simple matter to transform it into frequency, for example by a Fourier transform:

$${f}_{i} ( t ) = {\sum }_{ω} {\hat{f}}_{i} ( ω ) {e}^{i ω t}$$

and the frequency-domain traces \hat{ƒ}ᵢ(ω) may be separated into an amplitude term α and a phase term p:

\hat{ƒ}ᵢ(ω)=αᵢ(ω)pᵢ(ω).

The amplitude and phase terms can be substituted into the stack power objective function J:

$$J = {\sum }_{t} {( s ( t ) )}^{2} = {\sum }_{t} {\sum }_{i , j} {f}_{i} ( t ) {f}_{j} ( t )$$

$$J = {\sum }_{t} {\sum }_{i , j} {\sum }_{ω , {ω}^{′}} {a}_{i} ( ω ) {a}_{j} ( ω ) {p}_{i} ( ω ) {p}_{j} ( ω ) {e}^{i ( ω + {ω}^{′} ) t}$$

which can be simplified using the property of delta function to

J=Σ_{i,j}Σ_{ω}αᵢ(ω)αⱼ(−ω)pⱼ(ω)ρⱼ(−ω).

As previously explained, the phase of the seismic energy is altered in a frequency dependent way when it encounters complex geology. In order to maximize stack power with respect to changes in the phase, the gradient of the objective function is computed:

$$\frac{\partial J}{\partial {p}_{k}} ( ω ) = {\sum }_{i , j} {a}_{i} ( ω ) {a}_{j} ( ω ) ( {δ}_{ik} {p}_{j}^{*} ( ω ) + {p}_{i} ( ω ) \frac{\partial {p}_{j}^{*} ( ω )}{\partial {p}_{k}} )$$

which can be simplified using the derivative property of the phase:

$$\frac{\partial }{\partial {p}_{k}} ( {p}_{j}^{*} ( ω ) ) = \frac{\partial }{\partial {p}_{k}} \frac{1}{{p}_{j} ( ω )} = - \frac{{δ}_{jk}}{{p}_{k}^{2} ( ω )}$$

to get a gradient that will vary the phase to find the optimal solution:

$$\frac{\partial J}{\partial {p}_{k}} ( ω ) = {\sum }_{i} {a}_{i} ( ω ) {a}_{k} ( ω ) ( {p}_{i}^{*} ( ω ) - \frac{{p}_{i} ( ω )}{{p}_{k}^{2} ( ω )} )$$

when it is set equal to zero. By applying a change of phase according to this gradient equation to the data for a particular frequency, the phases of the data across the partial image gathers can be brought into alignment. In an embodiment of this method, the Fourier transform and phase alignment are done in overlapping windows of data in time, so that the alignment is local. The alignment is then done for each frequency separately, using methods known to avoid cycle-skipping in the higher frequencies. The inverse Fourier transform of each partial image window is then taken, the aligned trace is then reassembled

In another embodiment, the alignment may be performed by aligning with a pilot trace. For example, a pilot trace might be created by stacking the partial image gather along the offset or angle axis. The stacking may be conventional summing, S/N stacking, or Kalman filter stacking. One skilled in the art will appreciate that there are other methods for generating the pilot trace that fall within the scope of this invention. Then each trace of the partial image gather can be correlated with the pilot trace and the maximum envelope of the correlation function can be used to phase shift the traces. The correlation may be performed for a small depth or time window. This method may use a Hilbert transform of the correlation function. The time/depth shift and phase rotation of the maximum envelope are used to align the each trace. Since the alignment may be frequency-dependent, it may be desirable to perform a S-transform of the pilot trace and each of the traces in the partial image gather, resulting in time-frequency traces that can then be cross-correlated and used to determine the appropriate depth/time shift. After the shift is applied, an inverse S-transform would be used. This process can then be repeated until the alignment is optimal.

In mathematical terms, the embodiment using a pilot trace may be explained as follows. Beginning with N traces Xᵢ(t), i=1,2, . . . ,N, in a typical stack process, a pilot trace M(t) may be constructed by

M(t)=Σᵢ₌₁^{N}Xᵢ(t),

where the summation is over trace number, and the summation is done at every time sample. In order to optimize stack power and extend this process to a frequency-dependent trace alignment, select a small time window around a given time sample on the partial image trace with an appropriate taper, and Fourier transform to give time-frequency data M(t,f) and Xᵢ(t,ƒ). One skilled in the art will appreciate that there are a variety of ways to accomplish this, including, by way of example and not limitation, an S-transform.

For each time sample window, and for every frequency range we assume there is a time shift τ(t, ƒ) and a phase shift b(t, ƒ) between the partial image trace and the pilot trace. The phase shift between the pilot trace and the partial image trace can be applied in the time domain using the trace and its Hilbert transform as follows. The phase shift between the pilot trace and the partial image trace can be expressed as

X(t)=∫X(ω)exp(iωt+b)dω,

where b is the phase shift. This may be rewritten as

$$X ( t ) = \int X ( ω ) exp ( i ω t + b ) d ω = \int X ( ω ) exp ( i ω t ) ( cos b + i sin b ) d ω = X ( t ) cos b + {X}_{H} ( t ) sin b .$$

To estimate time and phase shift for a particular time window and frequency range, we maximize the stack power E(τ,b):

$$\begin{matrix}E ( τ , b ) = {\sum }_{t = t 1}^{t 2} {( M ( t ) + X ( t + τ ) )}^{2} \\ = {\sum }_{t = t 1}^{t 2} {M ( t )}^{2} + {\sum }_{t = t 1}^{t 2} {X ( t + τ )}^{2} + 2 {\sum }_{t = t 1}^{t 2} X ( t + τ ) M ( t ) ,\end{matrix}$$

where M(t) is the stack of all other traces except X(t) in the gather. As can be seen from this equation, to maximize the stack power it is only necessary to maximize the cross-correlation between the pilot trace and a seismic trace X(t). Therefore, the objective function to estimate b and t is to maximize the cross-correlation S(τ,b):

$$\begin{matrix}S ( τ , b ) = {\sum }_{t = t 1}^{t 2} M ( t ) X ( t + τ ) , \\ = R ( τ ) cos b + r ( t ) sin b ,\end{matrix}$$

where τ is varied over a suitable range. R(τ) is the real cross-correlation between pilot trace and the seismic trace, and r(τ) is Hilbert transform of R(τ). So the time shift and phase shift can be found from

$$\frac{\partial ( {R ( τ )}^{2} + {r ( τ )}^{2} )}{\partial τ} = 0 ,$$

and similarly for b. This means τ and b can be determined from the maximum envelop location of cross-correlation function (τ, b).

After the partial image gathers are optimally aligned, they are stacked at operation 16. This sums the partial image gathers along the partial image axis, which has been aligned to improve the focusing of the stacked events.

Although the embodiment of the invention shown in FIG. 1 illustrates the operations being performed in a particular sequence, this is not meant to be limiting. Some operations may be performed in parallel or in a different order. Other processing algorithms may also be included at various points in the workflow.

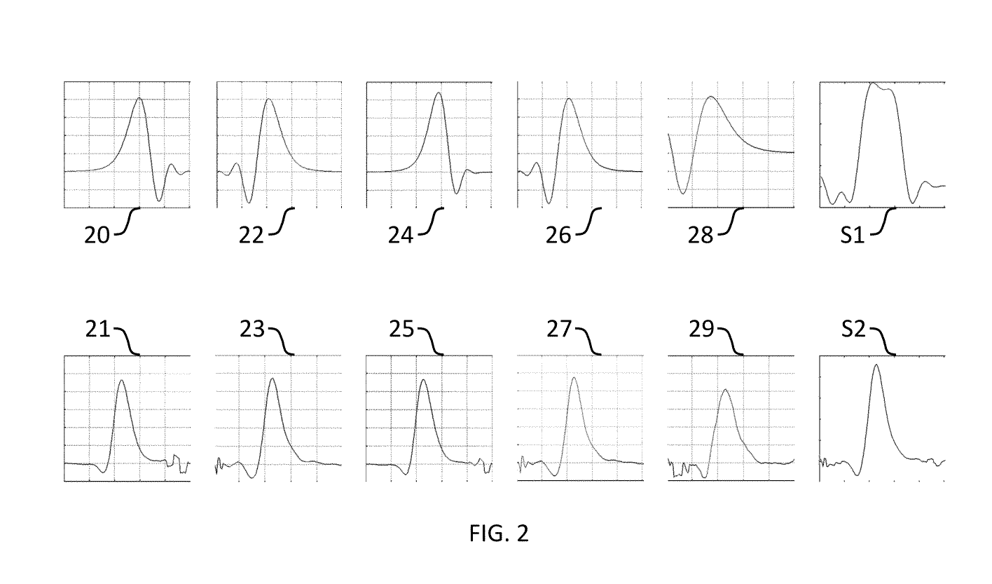

FIG. 2 shows a very simple, single event synthetic example. Panels 20, 22, 24, 26, and 28 show five seismic traces in which the seismic event has its phase slightly altered for each trace. Panel 51 shows the result of stacking the traces shown in panels 20, 22, 24, 26, and 28. Panel 21, 23, 25, 27, and 29 show the result of aligning the traces using an embodiment of the present invention. Panel S2 is the stack of panels 21, 23, 25, 27, and 29. Comparing the conventional stack 51 with the stack from the present invention S2, the event is cleaner and higher frequency after alignment has been performed.

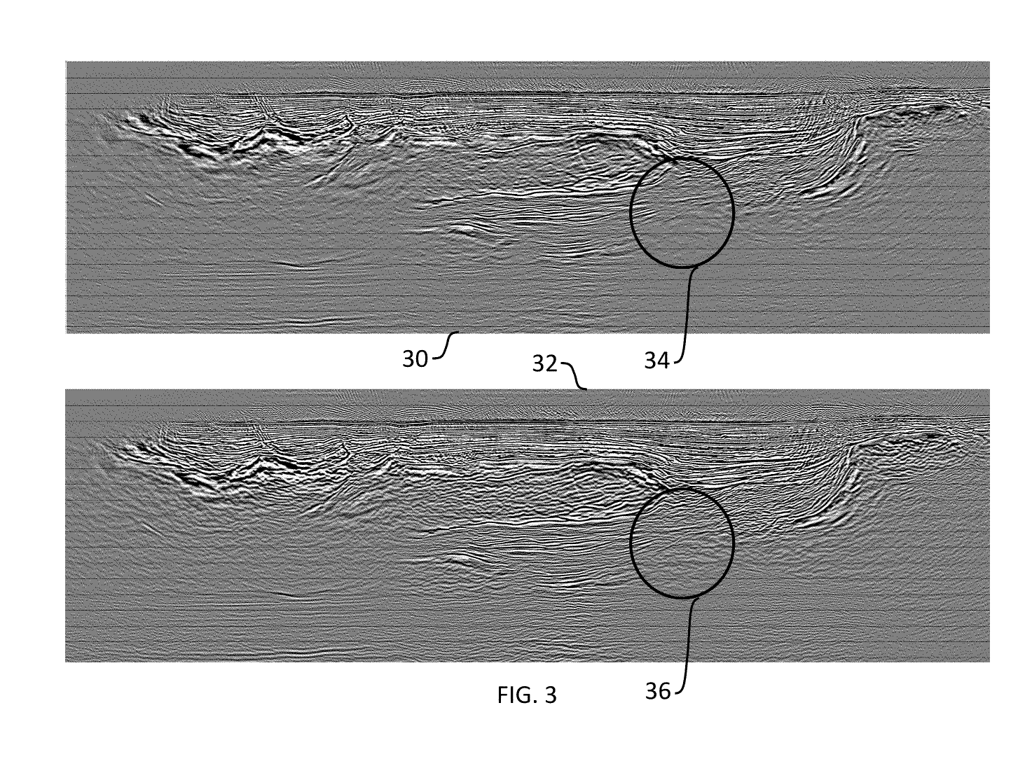

FIGS. 3-7 all show a comparison of a conventional stacked image (top panel) with a stacked image resulting from an embodiment of the present invention (bottom panel). In FIG. 3, the conventional stack 30 has poor illumination beneath the salt body, particularly in region 34. The improved stack of the present invention 32 has improved the image in region 36.

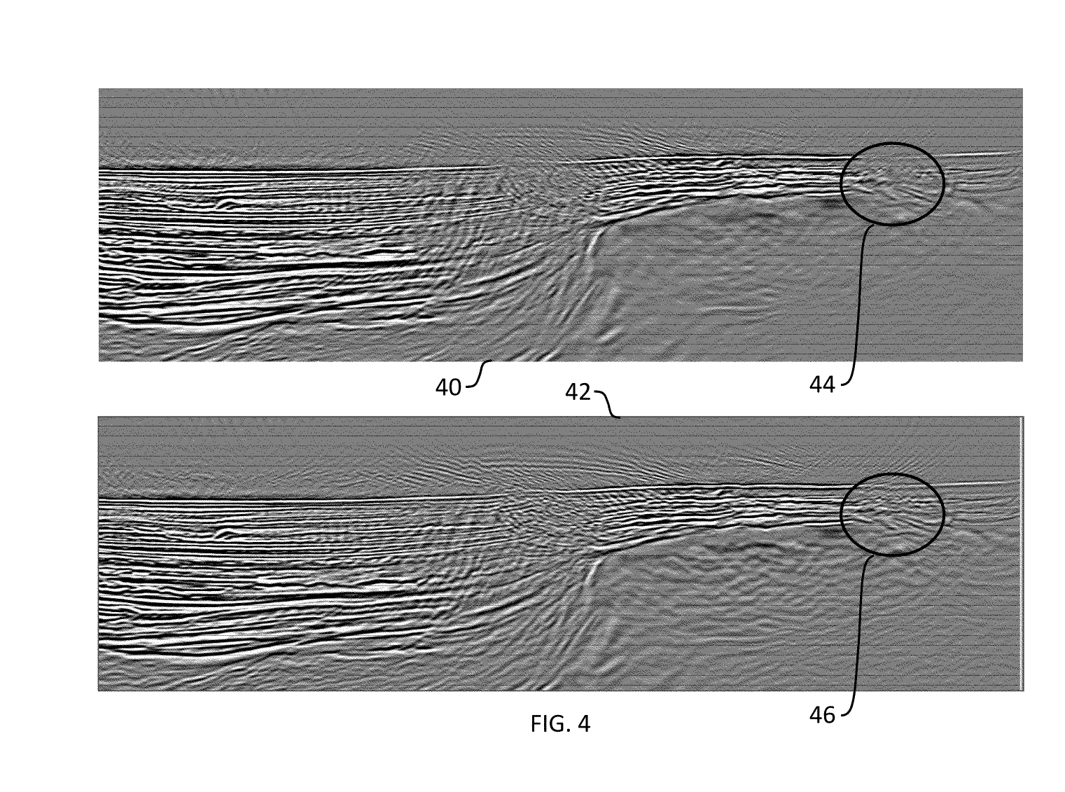

In FIG. 4, the conventional stack 40 has difficulty imaging the shallow region 44. The improved stack of the present invention 42 has continuous events, including the water bottom, in region 46.

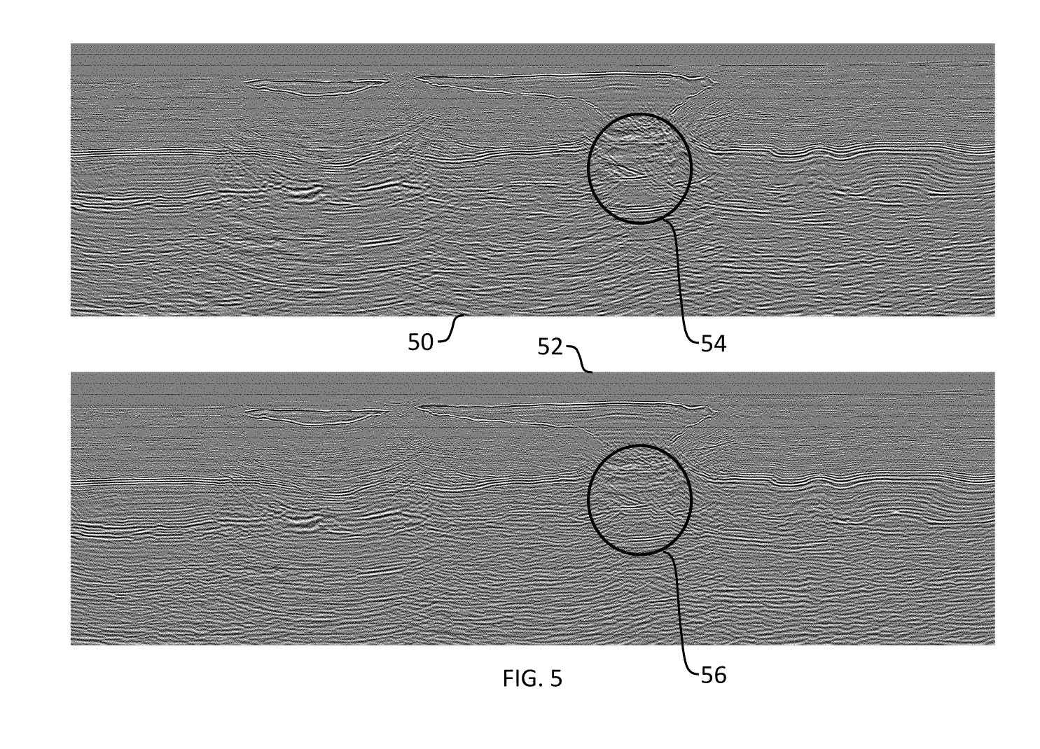

FIG. 5 is another image with a salt body that causes problems for the conventional stack 50, particularly in region 54. The improved stack of the present invention 52 has improved the image throughout the subsalt area, particularly in region 56.

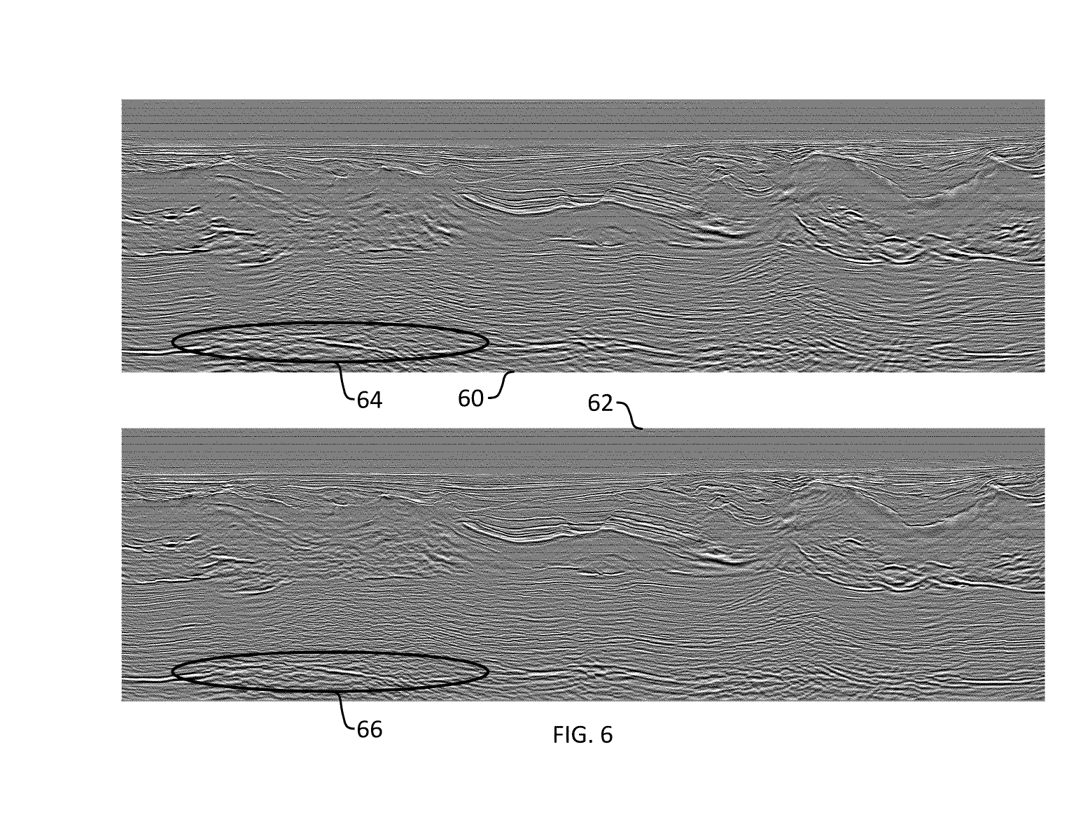

In FIG. 6, the conventional stack 60 has difficulty with the event in the deep region 64. The improved stack of the present invention 62 has improved the imaging of the deep event in region 66.

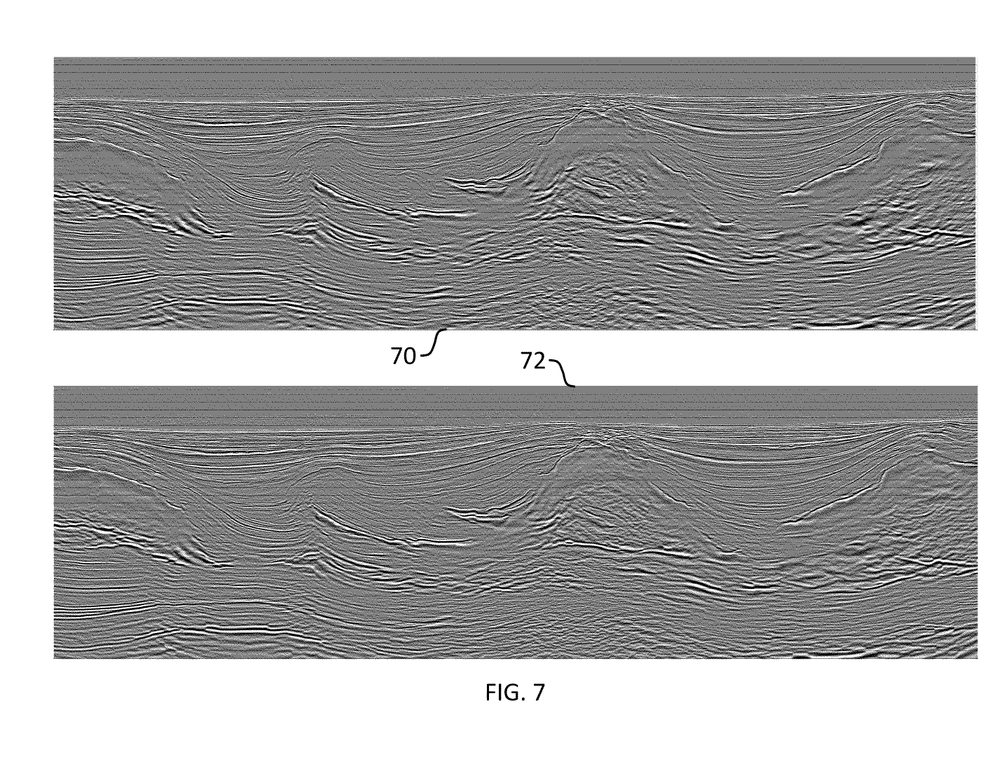

FIG. 7 has poor imaging throughout the conventional stack 70. The improved stack of the present invention 72 has improved the imaging.

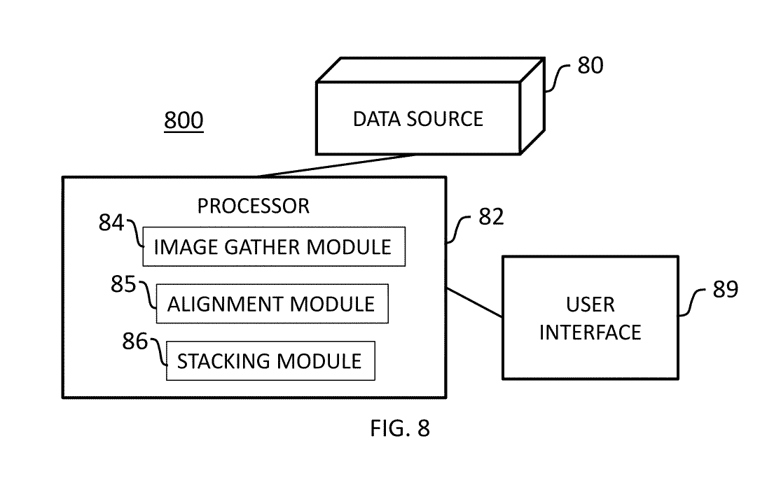

A system 800 for performing the method 100 of FIG. 1 is schematically illustrated in FIG. 8. The system includes a data source/storage device 80 which may include, among others, a data storage device or computer memory. The data source/storage device 80 may contain recorded seismic data or synthetic seismic data. The data from data source/storage device 80 may be made available to a processor 82, such as a programmable general purpose computer. The processor 82 is configured to execute computer modules that implement method 100. These computer modules may include an image gather module 84 for generating partial image gathers, an alignment module 85 for aligning the traces within a partial image gather based on frequency-dependent phase information, and a stacking module 86 for stacking the aligned gathers. These modules may include other functionality. In addition, other modules such as an inversion module to perform non-linear inversions may be used. The system may include interface components such as user interface 89. The user interface 89 may be used both to display data and processed data products and to allow the user to select among options for implementing aspects of the method. By way of example and not limitation, the input seismic data, the aligned gathers, and/or the stacks computed on the processor 82 may be displayed on the user interface 89, stored on the data storage device or memory 80, or both displayed and stored.

Those skilled in the art recognize that misalignment between partial images seen in a partial image gather can be used to change the model in order to alleviate that misalignment using various types of tomographic methods, as for example in a ray-based partial image tomography, or in a Full Waveform inversion, or in a Wave-Equation Migration Velocity Analysis. In the current specification of this invention, misalignment information between partial-image gathers is obtained in a frequency dependent way. This patent claims the use of any such frequency-dependent misalignment in the use of tomographic method to change the model parameters, which include but are not limited to velocity, density, and any anisotropic parameters, as well as absorption, and in particular, any model change that is made in a frequency dependent way, or extends the model domain to include frequency.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. In addition, it should be appreciated that structural features or method steps shown or described in any one embodiment herein can be used in other embodiments as well.

What is claimed is:

1. A computer-implemented method for seismic imaging of a complex subsurface volume of interest, the method comprising:
a. receiving, at a computer processor, a seismic dataset representative of the complex subsurface volume of interest;
b. generating, via the computer processor, partial image gathers from the seismic dataset;
c. aligning, via the computer processor, each of the partial image gathers based on frequency-dependent phase information to created aligned partial image gathers; and
d. stacking the aligned partial image gathers to produce a seismic image of the subsurface.

2. The method of claim 1 wherein the aligning operation is performed by optimizing an objective function.

3. The method of claim 1 wherein the aligning operation is performed using a pilot trace.

4. The method of claim 1 further comprising:
a. calculating, via the computer processor, a frequency-dependent residual based on information from the aligning operation; and
b. performing a non-linear or linear tomographic inversion to determine a seismic model.

5. The method of claim 4 wherein the non-linear inversion uses an objective function and associated gradient and nonlinear optimization, or a Frechet derivative matrix.

6. The method of claim 4 wherein the seismic model includes at least one of velocity, density, elastic or anisotropic parameters, or an absorption parameter.

7. The method of claim 4 wherein a model parameter is extended to be a function of frequency

8. The method of claim 4 wherein a model parameter is extended to be a function of the partial image axis.

9. The method of claim 4 further comprising using the seismic model to identify local anomalies.

10. The method of claim 4 wherein the non-linear inversion updates high-contrast model parameter boundaries.

11. A system for seismic imaging of a complex subsurface volume of interest, the system comprising:
a. a data source containing seismic data representative of the subsurface volume of interest;
b. a computer processor configured to execute computer modules, the computer modules comprising:
i. an image gather module for creating partial image gathers;
ii. an alignment module for aligning the partial image gathers based on frequency-dependent phase information; and
iii. a stacking module; and
c. a user interface.

12. An article of manufacture including a non-transitory computer readable medium having computer readable code on it, the computer readable code being configured to implement a method for seismic imaging of a complex subsurface volume of interest, the method comprising:
a. generating partial image gathers from seismic dataset;
b. aligning each of the partial image gathers based on frequency-dependent phase information to created aligned partial image gathers; and
c. stacking the aligned partial image gathers to produce a seismic image of the subsurface.
